(19) United States
(12) Patent Application Publication
(10) Pub. No.: US 2013/0262683 A1
(43) Pub. Date: Oct. 3, 2013

(54) PARALLEL COMPUTER SYSTEM AND CONTROL METHOD

(71) Applicant: FUJITSU LIMITED, Kawasaki-shi (JP)

(72) Inventors: Naoki HAYASHI, Kawasaki (JP); Tsuyoshi Hashimoto, Kawasaki (JP)

(73) Assignee: FUJITSU LIMITED, Kawasaki-shi (JP)

(21) Appl. No.: 13/832,266

(22) Filed: Mar. 15, 2013

(30) Foreign Application Priority Data
Mar. 27, 2012 (JP) 2012-071235

(51) Int. Cl. H04L 12/70

(52) U.S. Cl. CPC H04L 47/70
USPC 709/226

(57) ABSTRACT

A disclosed control method is executed by a node of plural nodes that are connected in a parallel computer system through a network. The control method includes obtaining property data representing a property of accesses to data stored in a storage device in a first node of the plural nodes for a job to be executed by using data stored in the storage device, and determining a resource to be allocated to a cache among resources included in the parallel computer system and the network based on the obtained property data.

### CROSS-REFERENCE TO RELATED APPLICATIONS

This application is based upon and claims the benefit of priority of the prior Japanese Patent Application No. 2012-071235, filed on Mar. 27, 2012, the entire contents of which are incorporated herein by reference.

### FIELD

This invention relates to a parallel computer and a control method of the parallel computer.

### BACKGROUND

In a system for performing large-scale calculations (for example, a parallel computer system such as a super computer), a lot of nodes, each of which has a processer and memory, work together to perform the calculation. In such a system, each node performs a series of processes such as executing jobs using data on a disk in a file server included in the system, and writing back the execution results on the disk in the file server. In this case, in order to increase the speed of the processing, each node executes jobs after storing data used for the execution of the jobs in a high-speed storage device such as memory (in other words, a disk cache). However, in recent years, calculations are increasingly becoming larger-scale, and with the disk cache technology that has been used up until now, it is no longer possible to sufficiently improve the throughput of the system.

Conventionally, there has been a technique in which a disk cache is located inside the disk housing of the file server and that disk cache is managed by a disk controller. However, this disk cache is normally a non-volatile memory, and so there is a problem in that it is more expensive when compared with a volatile memory that is normally used for a main storage device (in other words, main memory). Moreover, because the disk cache is controlled comparatively simply by the hardware and firmware, the capacity of the disk cache is limited. In consideration of the problems above, such a conventional technique is not suitable for the aforementioned system for performing large-scale calculations.

There is also a technique in which a disk cache is located in the main storage device of a server in a distributed file system or DataBase Management System (DBMS). However, due to requirements related to the maintenance of the consistency in data management, only one or a few disk cache can be provided for the data on each disk. Therefore, when accesses are concentrated on a disk, the server may not cope with the accesses, and as a result, there may be a drop in throughput of the system.

Furthermore, there is a technique for setting the data storage disposition based on access history. More specifically, the history of past accesses from the CPU is recorded, and the trend or pattern of accesses is predicted from the recorded past access history. In the predicted access pattern, the data disposition is determined such that the response speed becomes faster. Then, according to the determined data disposition, allocated data is relocated. However, this technique is for the disposition of data inside a device, and cannot be applied to the system such as described above.

Moreover, there is also a technique for differently using storage devices according to the situation. More specifically, in a hierarchical storage device that includes the layers of a memory, a hard disk, a portable storage medium drive device and portable storage medium library device, the upper two layers (memory and hard disk) are used as a cache of the lower devices. In addition, the optimum construction of the hierarchical storage device that is possible within a limited cost is calculated based on the access history. However, this technique is also a technique related to the optimization of the construction of plural storage devices within the device, and cannot be applied to the system such as described above.

In this way, there is no technique for suitably disposing a disk cache in a system that includes plural nodes such as described above.

### SUMMARY

A control method relating to this invention is executed by a node of plural nodes in a parallel computer system, which are connected through a network. Then, this control method includes: (A) obtaining property data representing a property of accesses to data stored in a storage device in a first node of the plural nodes for a job to be executed by using data stored in the storage device, and (B) determining a resource to be allocated to a cache among resources included in the parallel computer system and the network based on the obtained property data.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram to explain an outline of embodiments;

FIG. 2 is a diagram to explain the outline of the embodiments;

FIG. 3 is a diagram illustrating a system outline of the embodiments;

FIG. 4 is a diagram depicting an arrangement example of calculation nodes and cache servers;

FIG. 5 is a diagram to explain writing of data by the calculation node;

FIG. 6 is a functional block diagram of the calculation node;

FIG. 7 is a functional block diagram of the cache server;

FIG. 8 is a diagram depicting a processing flow of a processing executed by a property manager;

FIG. 9 is a diagram depicting an example of data stored in a property data storage unit;

FIG. 10 is a diagram depicting an example of data stored in the property data storage unit;

FIG. 11 is a diagram depicting a processing flow of a processing executed by a resource allocation unit;

FIG. 12 is a diagram depicting a processing flow of a resource allocation processing;

FIG. 13 is a diagram depicting an example of data stored in a list storage unit;

FIG. 14 is a diagram depicting an example of an optimization processing;

FIG. 15 is a diagram depicting an example of data stored in a bandwidth data storage unit;

FIG. 16 is a diagram depicting an example of a system;

FIG. 17 is a diagram depicting an example of a weighted directed graph;

FIG. 18 is a diagram depicting an example of a system to which the virtualization is applied;

FIG. 19 is a diagram depicting an example of the weighted directed graph in case where the virtualization is performed;

FIG. 20 is a diagram depicting a data compression method;

FIG. 21 is a diagram depicting a processing flow of a processing executed by a bandwidth calculation unit;

FIG. 22 is a functional block diagram of the calculation node;

FIG. 23 is a diagram depicting a processing flow of a processing executed by the property manager;

FIG. 24 is a diagram depicting an example of data stored in the property data storage unit;

FIG. 25 is a diagram depicting a processing flow of a processing executed by the property manager and resource allocation unit;

FIG. 26 is a diagram depicting a processing flow of a processing for identifying an allocation method;

FIG. 27 is a diagram depicting an example of data stored in an allocation data storage unit;

FIG. 28 is a diagram depicting an example of an execution program of the job;

FIG. 29 is a diagram depicting a processing flow of a processing executed by the property manager;

FIG. 30 is a diagram depicting an example of data stored in the property data storage unit;

FIG. 31 is a diagram depicting an example of a script file;

FIG. 32 is a diagram depicting a processing flow of a processing executed by a job scheduler; and

FIG. 33 is a functional block diagram of a computer.

### DESCRIPTION OF EMBODIMENTS

### Outline of Embodiments

First, an outline of embodiments relating to this invention will be explained. In a system of the embodiments, calculation nodes perform a series of processes as a disk cache such as executing jobs using data that is read from a disk of a file server and writing back the execution results in the disk in the file server. Here, cache servers are placed around the calculation nodes, and by making it possible to store data in the memory of a cache server, a processing by the calculation node is made faster.

Then, the system of the embodiments have a function (hereinafter, called a property management function) for extracting properties of accesses to a disk by a calculation node, and a function (hereinafter, called a resource allocation function) for allocating resources in the system for the cache according to the properties of accesses.

The property management function includes at least either of the functions below. (1) Function for recording property data (for example, the number of input bytes, the number of output bytes, and the like) at predetermined time intervals during execution of a job, and dynamically predicting property data for the next predetermined time period based on the recorded property data. (2) Function for obtaining property data in advance for each execution stage of the job.

The resource allocation function includes at least either of the functions below. (1) Function for allocating resources according to a default setting or based on the property data generated by the property management function at the start of the job execution. (2) Function for allocating resources based on the property data generated by the property management function in each stage of the job execution.

Furthermore, the resources that are allocated by the resource allocation function for the cache include at least either of the following elements. (1) Node at which a program (hereinafter, called a cache server program) for operating as a cache server is executed. (2) Memory that is used by the cache server program that is executed by the cache server. (3) Communication bandwidth that is used when data is transferred among the calculation nodes, cache servers and file servers.

In this way, in the embodiments, nodes that are operated as the cache servers, memory that is used for the processing by the cache servers, data transfer paths, and the like can be dynamically changed according to the property of the accesses to the disk by the calculation nodes.

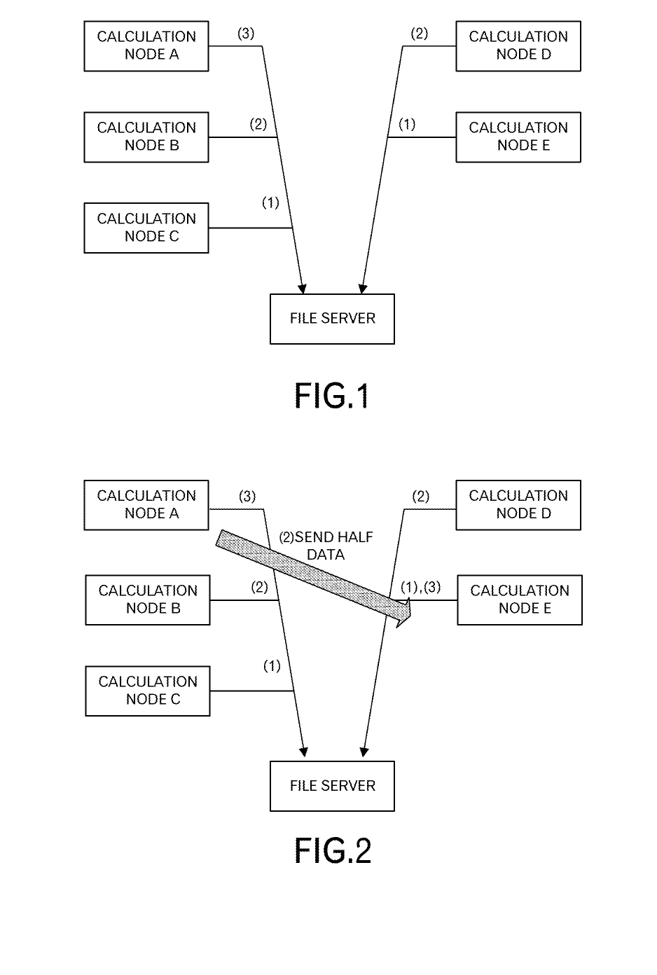

As an example, a case is explained in which the processing time is shortened by causing the calculation node to operate as a cache server. FIG. 1 and FIG. 2 are drawings to explain such a case. In FIG. 1 and FIG. 2, a situation is presumed in which after calculation nodes A to E have performed a processing, data that includes the processing results is written back to a file server. Moreover, in order to simplify the explanation, it is presumed that the system in FIG. 1 and FIG. 2 is a system such as described below.

i) The bandwidth that can be used when the file server receives data from the calculation node is double the bandwidth that can be used when the calculation node transmits data to the file server. Moreover, the bandwidth that can be used when the calculation node transmits data is the same regardless of the transmission destination. ii) The calculation nodes are classified into two groups. The respective communication paths from the calculation nodes to the file server are independent. The number of nodes included in each group is not the same.

The system in FIG. 1 is a system in which the calculation nodes are not converted to a cache server. In this system, in stage (1), the calculation node C and calculation node E transmit data to the file server; in stage (2), the calculation node B and calculation node D transmit data to the file server; and in stage (3), the calculation node A transmits data to the file server. Presuming that the times required for stages (1), (2) and (3) are the same, the total required time becomes three times that of the time required for one calculation node to transmit data to the file server.

On the other hand, the system in FIG. 2 is a system in which the calculation nodes can be converted to cache servers. In this system, in stage (1), the calculation node C and calculation node E transmit data to the file server. In stage (2), the calculation node B and calculation node D transmit data to the file server, and the calculation node A transmits half data to the calculation node E. In other words, the calculation node E is used as a cache server.

Then, in stage (3), the calculation node A and calculation node E transmit data (half the amount of the data that was transmitted to the file server by the calculation node B, calculation node C and calculation node D) to the file server. In the system in FIG. 2, the time required for the stage (1) and the time required for the stage (2) is the same as in the system in FIG. 1, however, the time required for the stage (3) is half the time required for the stage (1) and stage (2). Therefore, the total time required becomes 2.5 times longer than the time required for one calculation node to transmit data to the file server. In other words, by causing the calculation node E to function as the cache server, the total required time is decreased.

In the embodiments, by appropriately allocating resources of the system to the cache when executing a job in this way, it becomes possible to improve the overall processing performance of the system. In the following, the embodiments will be described in more detail.

### Embodiment 1

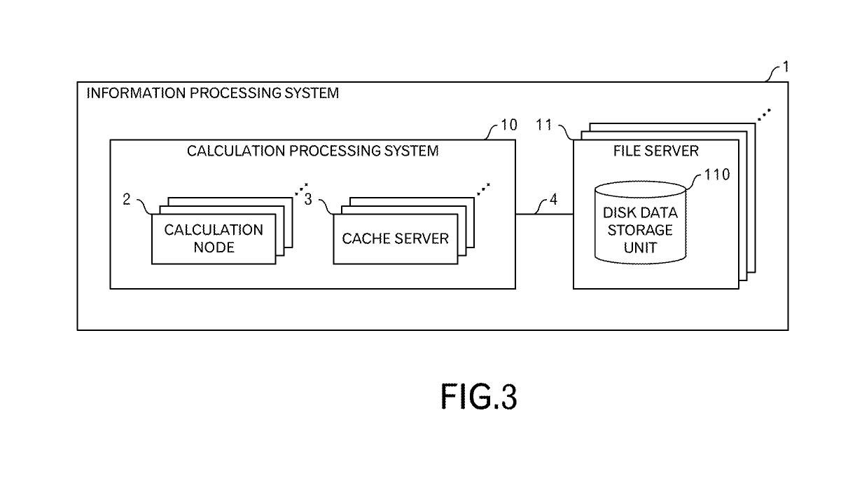

FIG. 3 illustrates a system outline in a first embodiment. For example, an information processing system 1, which is a parallel computer system, includes a calculation processing system 10 that includes plural calculation nodes 2 and plural cache servers 3, and plural file servers 11 that include a disk data storage unit 110. The calculation processing system 10 and the plural file servers 11 are connected by way of a network 4. The calculation processing system 10 is a system in which each of the calculation node 2 and cache server 3 has CPUs (Central Processing Units), memories and the like.

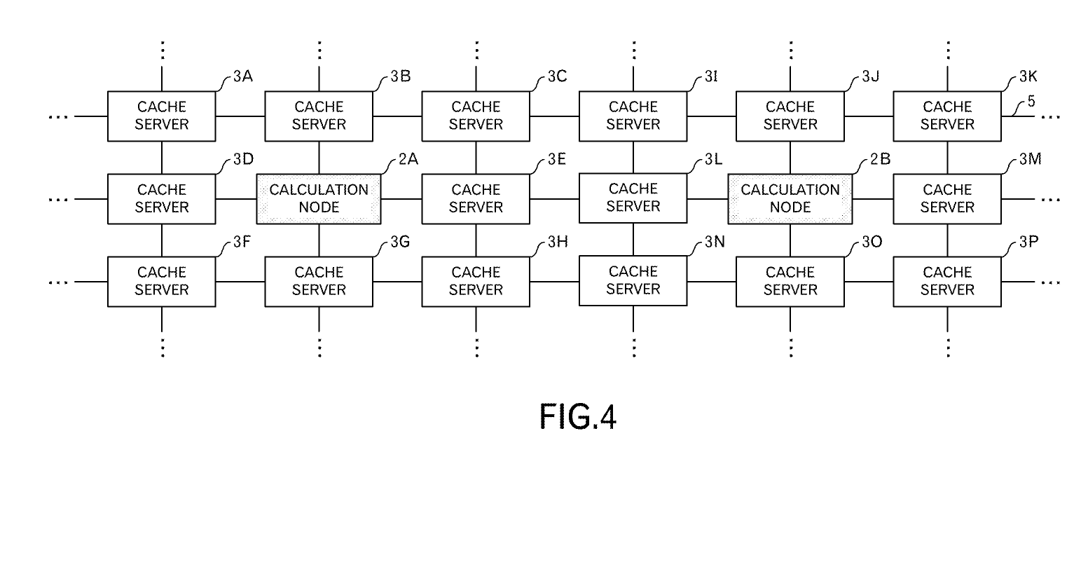

FIG. 4 illustrates an example of the arrangement of the calculation nodes 2 and cache servers 3 in the calculation processing system 10. In the example of FIG. 4, cache servers 3A to 3H are arranged around the calculation node 2A, and cache servers 3A to 3H are able to perform communication with calculation node 2A with 1 hop or 2 hops by way of interconnects 5. Similarly, cache servers 31 to 3P are arranged around the calculation node 2B, and cache servers 31 to 3P are able to perform communication with the calculation node 2B with 1 hop or 2 hops by way of interconnects 5.

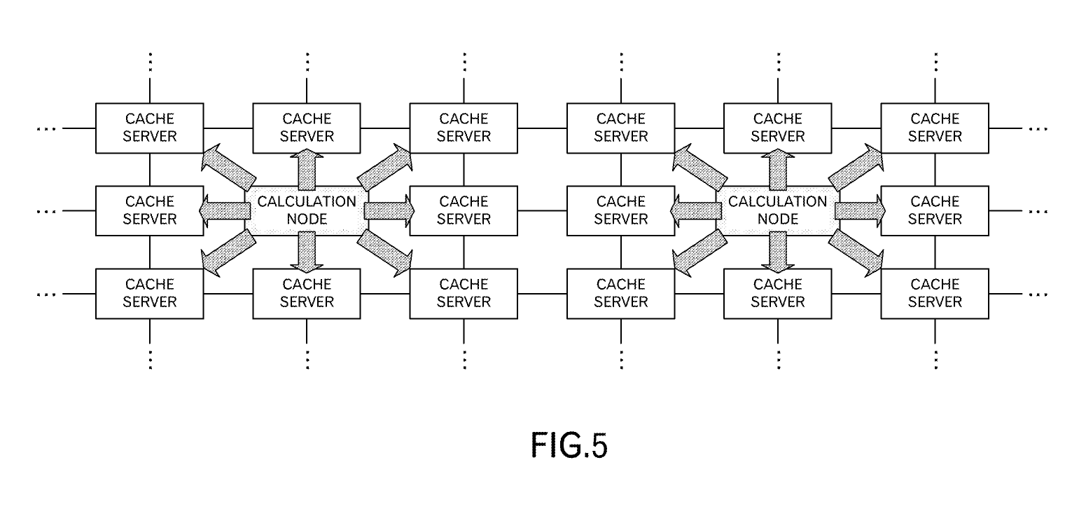

For example, as illustrated in FIG. 5, it is possible for the calculation nodes 2A and 2B to use cache servers that are arranged around the calculation nodes 2A and 2B, when the calculation nodes 2A and 2B execute jobs. In other words, the calculation node 2A executes a job by writing data that is stored in the disk data storage unit 110 to the memories or the like in the cache servers 3A to 3H. Moreover, the calculation node 2B executes a job by writing data that is stored in the disk data storage unit 110 to the memories or the like in the cache servers 31 to 3P. When execution of the job is finished, the data that was stored in the memories in the cache servers is written back to the disk data storage unit 110 in the file server 11.

The following presumptions are also made for the system of this first embodiment. (1) The cache servers 3 are arranged between the calculation nodes 2 and the file servers 11. (2) Plural jobs use one cache server 3. (3) There are plural cache servers 3, and the cache server 3 that is used by each job can be changed during the execution of the job.

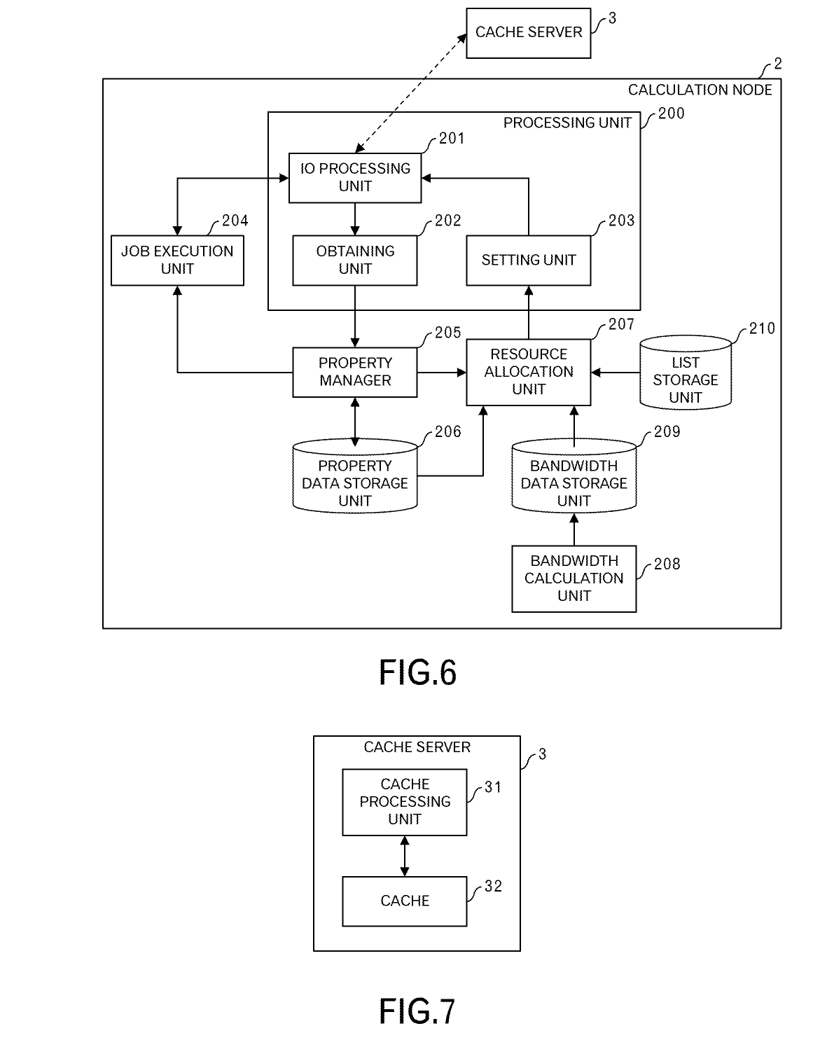

FIG. 6 illustrates a function block diagram of the calculation node 2. In the example in FIG. 6, the calculation node 2 includes a processing unit 200 that includes an IO (Input Output) processing unit 201, an obtaining unit 202 and a setting unit 203, a job execution unit 204, a property manager 205, a property data storage unit 206, a resource allocation unit 207, a bandwidth calculation unit 208, a bandwidth data storage unit 209 and a list storage unit 210.

The IO processing unit 201 carries out a processing of outputting data received from the cache server 3 to the job execution unit 204, or carries out a processing of transmitting data that is obtained from the job execution unit 204 to the cache server 3. The obtaining unit 202 monitors a processing by the IO processing unit 201 and outputs data that represents the disk access properties (for example, information that represents the number of disk accesses per unit time, the number of input bytes, the number of output bytes and the position of accessed data and the like. Hereinafter, this will be called property data.) to the property manager 205. The job execution unit 204 executes a job using data that is received from the IO processing unit 201, and outputs data including the execution results to the IO processing unit 201. The property manager 205 calculates predicted values using the property data and stores those values in the property data storage unit 206. Moreover, the property manager 205 monitors a processing by the job execution unit 204, and requests the resource allocation unit 207 to allocate the resources according to the state of the processing. The bandwidth calculation unit 208 calculates the bandwidth that can be used for each communication path of the calculation node 2, and stores the processing results in the bandwidth data storage unit 209. Moreover, the bandwidth calculation unit 208 transmits the calculated bandwidth to the other calculation nodes 2, cache servers 3 and file servers 11. In response to a request from the property manager 205, the resource allocation unit 207 carries out a processing using data that is stored in the property data storage unit 206, data that is stored in the bandwidth data storage unit 209 and data that is stored in the list storage unit 210, and outputs the processing results to the setting unit 203. The setting unit 203 carries out setting of the caches for the IO processing unit 201 according to the processing results received from the resource allocation unit 207.

FIG. 7 illustrates a function block diagram of the cache server 3. The cache server 3 includes a cache processing unit 31 and a cache 32. The cache processing unit 31 carries out input of data to or output of data from the cache 32.

Next, a processing that is carried out by the system illustrated in FIG. 3 will be explained. First, the processing that is carried out by the property manager 205 when a job is being executed by the job execution unit 204 will be explained.

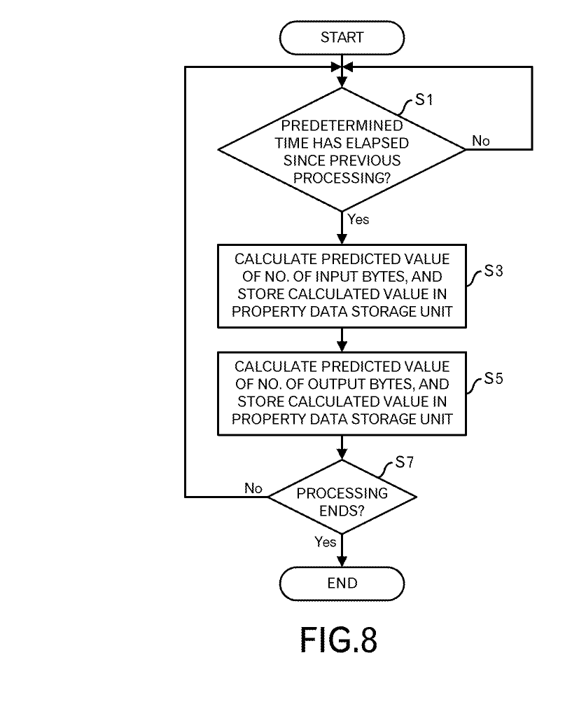

First, the property manager 205 determines whether or not a predetermined amount of time has elapsed since the previous processing (FIG. 8: step S1). When the predetermined amount of time has not elapsed (step S1: NO route), it is not the timing to execute the processing, so the processing of the step S1 is executed again.

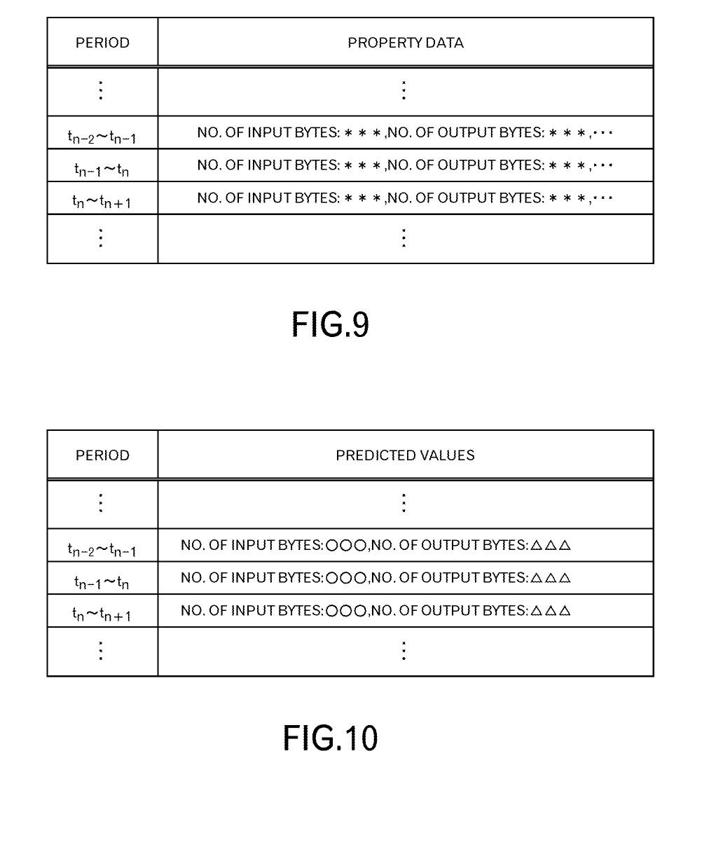

On the other hand, when the predetermined amount of time has elapsed (step S1: YES route), the property manager 205 receives the property data from the obtaining unit 202, and stores the property data in the property data storage unit 206. FIG. 9 illustrates an example of data that is stored in the property data storage unit 206. In the example in FIG. 9, the property data (for example the number of input bytes and the number of output bytes) is stored for each period of time.

Then, the property manager 205 uses the data that is stored in the property data storage unit 206 to calculate a predicted value for the number of input bytes for the next predetermined period of time, and stores that predicted value in the property data storage unit 206 (step S3). The predicted value for the number of input bytes is calculated, for example, as described below.

D(N)=(the number of input bytes N times ago−the number of input bytes (N+1) times ago)

E(N)=(½)^{N}*D(N)

Predicted value for the number of input bytes=(2^{M}−1)*{E(1)+E(2)+ . . . +E(M)}/2^{M-1}

Here, M and N are natural numbers.

Moreover, the property manager 205 uses the data stored in the property data storage unit 206 to calculate a predicted value for the number of output bytes for the next predetermined time period, and stores that predicted value in the property data storage unit 206 (step S5). The predicted value for the number of output bytes is calculated, for example, as described below.

D(N)=(the number of output bytes N times ago−the number of output bytes (N+1) times ago)

E(N)=(½)^{N}*D(N)

Predicted value for the number of output bytes=(2^{M}−1)*{E(1)+E(2)+ . . . +E(M)}/2^{M-1}

Here, M and N are natural numbers.

FIG. 10 illustrates an example of predicted values that are stored in the property data storage unit 206. In the example in FIG. 10, the predicted values for the number of input bytes and the number of output bytes are stored for each time period. For example, the predicted values for the number of input bytes and the number of output bytes, which correspond to time tₙ, are predicted values that are calculated using data for the numbers of input bytes and the numbers of output bytes from time t₀ to time tₙ₋₁.

Then, the property manager 205 determines whether or not the processing is terminated (step S7). When the processing is not terminated (step S7: NO route), the processing returns to the step S1. For example, when the execution of the job is finished (step S7: YES route), the processing ends.

By performing the processing such as described above, it becomes possible to predict disk access properties for a next predetermined time period based on the property data that is acquired at predetermined time intervals during the execution of the job.

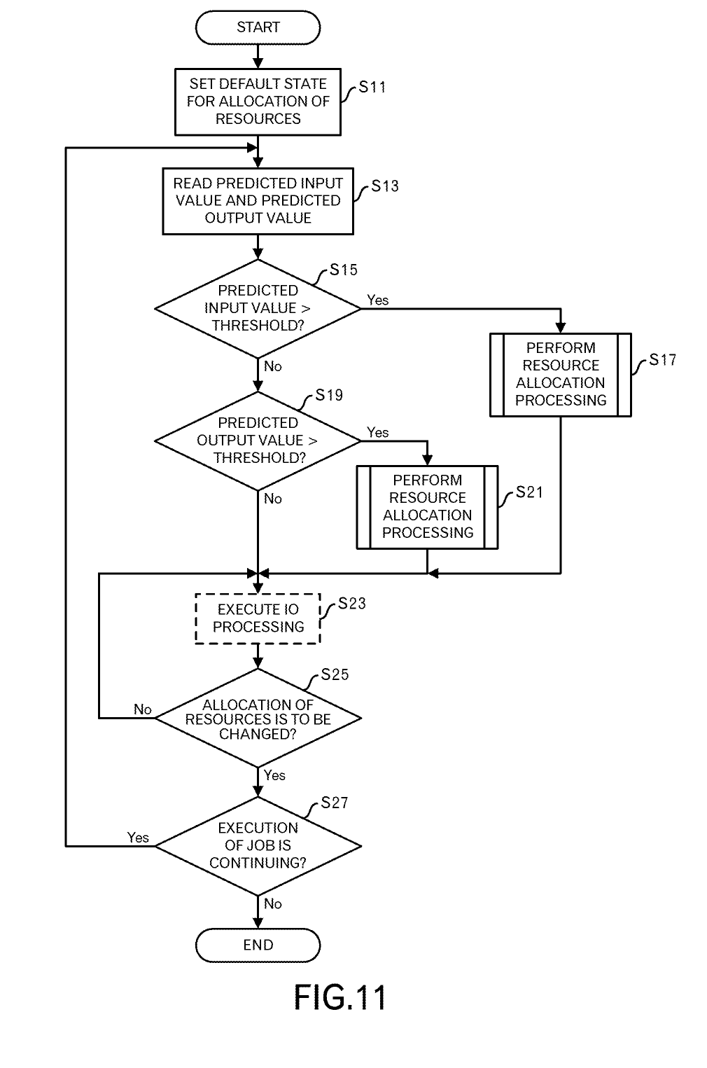

Next, a processing that is performed by the resource allocation unit 207 when the execution of the job is started by the job execution unit 204 will be explained. First, the resource allocation unit 207 sets a default state for allocation of resources (FIG. 11: step S11). At the step S11, the resource allocation unit 207 requests the setting unit 203 so as to set the default state for the allocation of the resources. In response to this, the setting unit 203 sets the default state for the allocation of resources. For example, the setting unit 203 conducts a setting so that the IO processing unit 201 uses only a predetermined cache server 3.

The resource allocation unit 207 reads the most recent predicted value for the number of input bytes (hereinafter, called the predicted input value) and the predicted value for the number of output bytes (hereinafter, called the predicted output value) from the property data storage unit 206 (step S13).

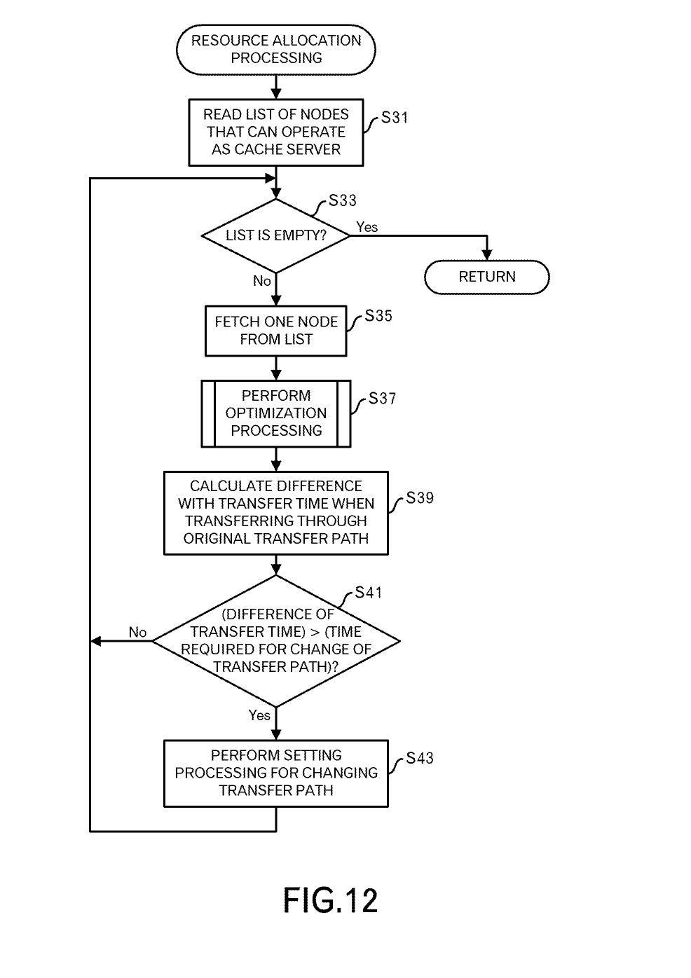

The resource allocation unit 207 determines whether the predicted input value is greater than a predetermined threshold value (step S15). When the predicted input value is greater than the predetermined threshold value (step S15: YES route), the resource allocation unit 207 carries out a resource allocation processing (step S17). The resource allocation processing will be explained using FIG. 12 to FIG. 20.

First, the resource allocation unit 207 reads, from the list storage unit 210, a list of nodes that can be operated as the cache servers (FIG. 12: step S31).

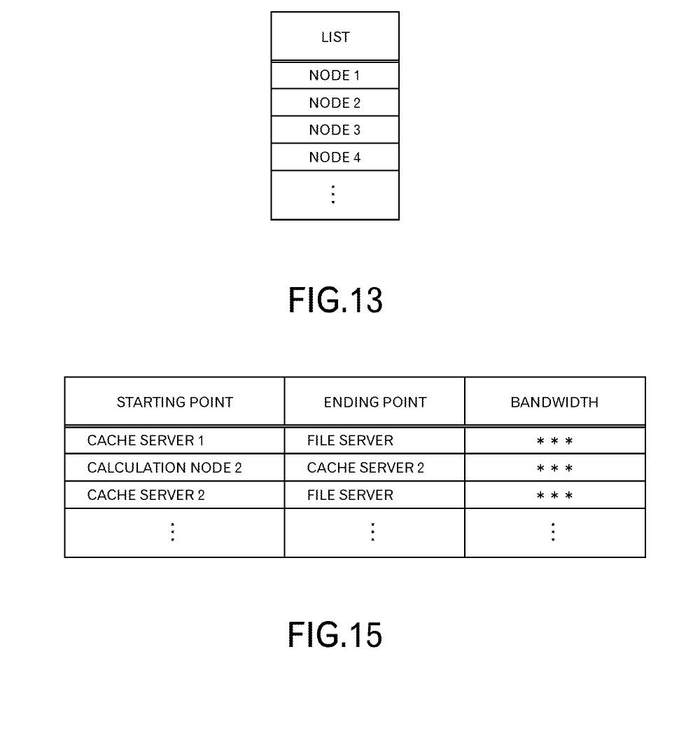

FIG. 13 illustrates an example of data that is stored in the list storage unit 210. In the example in FIG. 13, node identification information is stored. Nodes whose identification information is stored in the list storage unit 210 are calculation nodes 2 that can be converted to the cache servers 3 (for example, calculation nodes 2 that are not executing a job) among the calculation nodes 2.

The resource allocation unit 207 determines whether or not the list is empty (step S33). When the list is empty (step S33: YES route), the processing returns to the calling-source processing.

On the other hand, when the list is not empty (step S33: NO route), the resource allocation unit 207 fetches one node from the list (step S35).

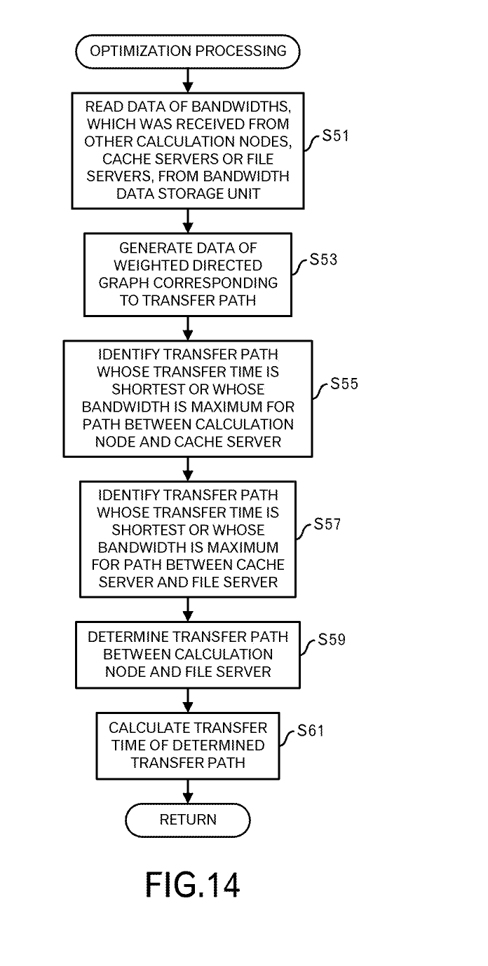

Then, the resource allocation unit 207 carries out an optimization processing (step S37). The optimization processing will be explained using FIG. 14 to FIG. 20. The node that was fetched at the step S35 is treated hereinafter as being a cache server 3.

First, the resource allocation unit 207 reads data of the bandwidth, which was received from other calculation nodes 2, cache servers 3 and file servers 11 from the bandwidth data storage unit 209 (FIG. 14: step S51).

FIG. 15 illustrates an example of data that is stored in the bandwidth data storage unit 209. In the example in FIG. 15, identification information of the node that is the starting point, identification information of the node that is the ending point, and the bandwidth that can be used are stored. This will be explained in detail later, however, the data that is stored in the bandwidth data storage unit 209 is data that the bandwidth calculation unit 208 received from other calculation nodes 2, cache servers 3 and file servers 11.

The resource allocation unit 207 uses data that is stored in the bandwidth data storage unit 209 to generate data for a “weighted directed graph that corresponds to the transfer path”, and stores generated data in a storage device such as a main memory (step S53).

At the step S53, the weighted directed graph that corresponds to the transfer path is generated as described below.

A node (here, calculation nodes 2, cache servers 3 or file servers 11) is handled as a “vertex”. A communication path between nodes is handled as an “edge”. The bandwidth (bits/second) that can be used in each communication path (in other words, the bandwidth that cannot be used by other jobs) is handled as a “weight”. The direction of the data transfer is handled as a “direction of an edge in the graph”.

Here, the “direction” is the data transfer direction of each communication path when the starting point and the ending point are set as described below.

In communication when the calculation node 2 reads data from the disk data storage unit 110 in the file server 11, the starting point is the file server 11 and the ending point is the calculation node 2. In communication when the calculation node 2 writes data to the disk data storage unit 110 in the file server 11, the starting point is the calculation node 2 and the ending point is the file server 11.

The weighted directed graph that corresponds to the transfer path is stored as matrix data in the memory of the node. The matrix data is generated as described below.

(1) A serial number is allocated to each node in a network. (2) The bandwidth that can be used in a communication path from an i-th node to a j-th node is the (i, j) component in the matrix. (3) When there is no communication path from the i-th node to the j-th node, or when that communication path cannot be used, “0” is set to the (i, j) component.

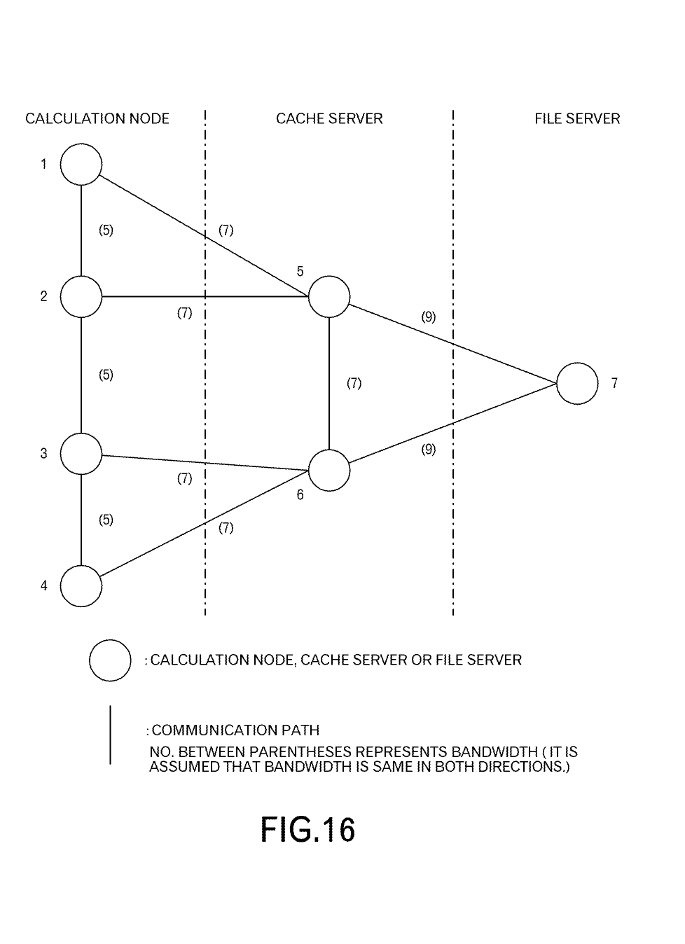

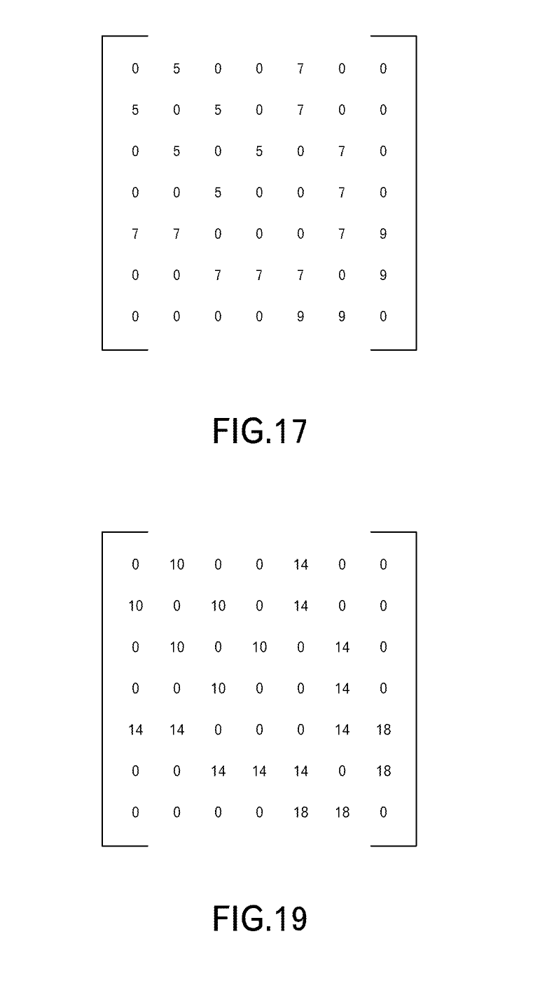

For example, when the serial number of each node in a network and the bandwidth that can be used in each communication path are as illustrated in FIG. 16, matrix data such as illustrated in FIG. 17 is generated. In FIG. 16, the circles represent nodes, the numbers attached to the nodes represent serial numbers, the line segments that connect between nodes represent communication paths, and the numbers in brackets attached to each communication path represent usable bandwidths. However, in order to simplify the explanation, the bandwidth that can be used in the communication path from the i-th node to the j-th node is presumed to be the same as the bandwidth that can be used in the communication path from the j-th node to the i-th node.

It is also possible to execute the following virtualization for the nodes and communication paths in a weighted directed graph that corresponds to a transfer path. The virtualization referred to here means lumping together plural physical nodes or plural physical paths to map them to one virtual vertex or one virtual edge. As a result, it is possible to reduce the load of the optimization processing.

When plural file servers 11 are controlled by one parallel file system, those file servers 11 are regarded as one “virtual file server” to map them to one vertex. When doing this, the lumped respective communication paths of the plural file servers 11 are taken to be a “virtual communication path” that corresponds to the virtual file server. The calculation nodes that execute one job are classified into plural subsets (N₁, N₂, . . . Nₖ. Here, k is a natural number equal to or greater than 2.). Here, when the communication path between Nᵢ (i is a natural number) and the cache server 3, and the communication path between Nⱼ (j is a natural number) and the cache server 3 are separated so that there is no interference, Nᵢ and Nⱼ are virtually treated as one calculation node.

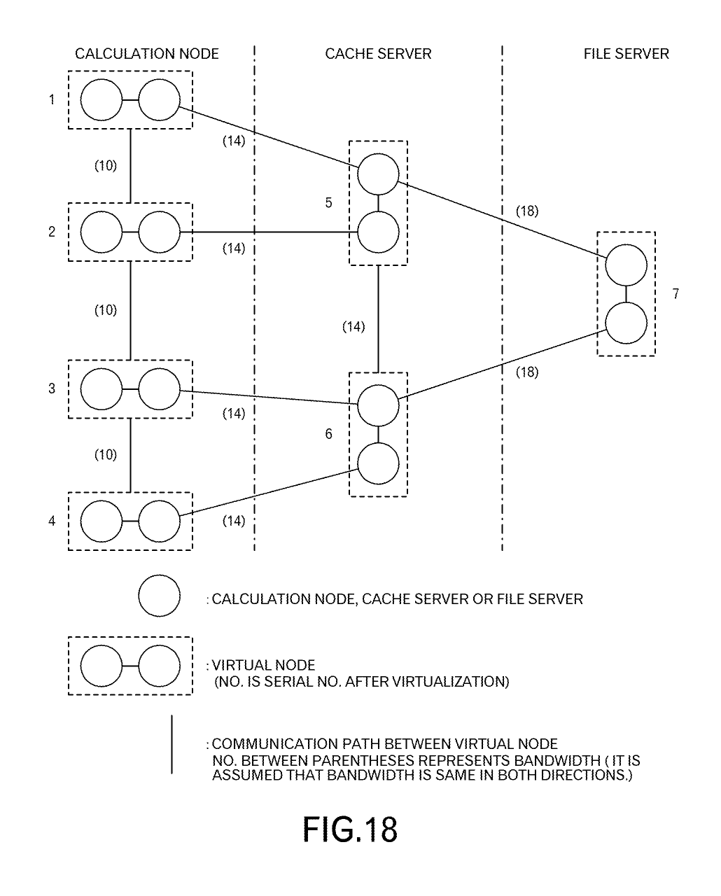

FIG. 18 illustrates an example of a directed graph when the virtualization is performed. In FIG. 18, circles represent nodes, line segments that connect between nodes represent communication paths, dashed line squares that include plural nodes represent virtualized nodes (hereinafter, called virtual nodes), and line segments that connect between virtual nodes represent virtual communication paths. Data of the directed graph in a matrix format, which is illustrated in FIG. 18, is as illustrated in FIG. 19.

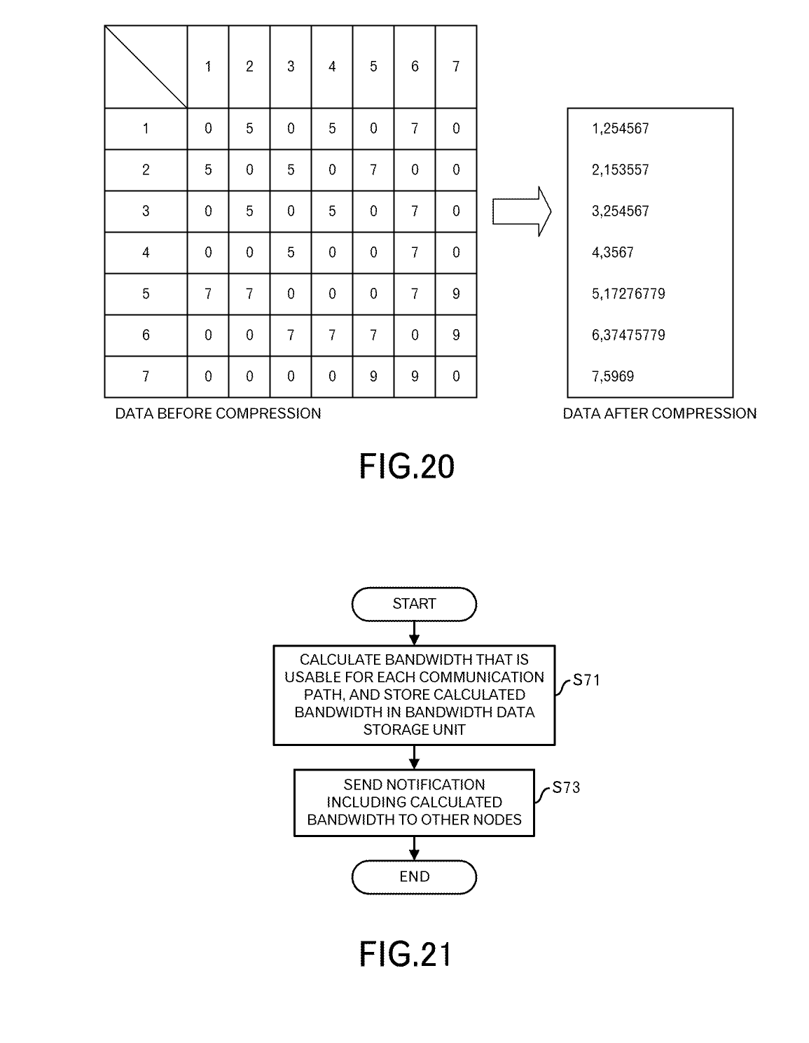

The data of the weighted directed graph that corresponds to the transfer paths can be compressed as illustrated in FIG. 20. In FIG. 20, the data on the left edge is data before the compression, and the data on the right edge is data after the compression. The compression method illustrated in FIG. 20 is explained using the first line of data as an example.

(1) The first number is the line number. Here, the first number is “1”. (2) The next is a comma. (3) Whether the number of the first column is a number other than “0” is determined. Here, the number of the first column is “0”, so nothing is performed. (4) Whether the number of the second column is a number other than “0” is determined. Here, the number of the second column is a number other than “0”, so the column number “2” is set as the third character, and the number “5” of the second column is set as the fourth character. (5) Whether the number of the third column is a number other than “0” is determined. Here, the number of the third column is “0”, so nothing is performed. (6) Whether the number of the fourth column is a number other than “0” is determined. Here, the number of the fourth column is a number other than “0”, so the column number “4” is set as the fifth character, and the number “5” of the fourth column is set as the sixth character. (7) Whether the number of the fifth column is a number other than “0” is determined. Here, the number of the fifth column is “0”, so nothing is performed. (8) Whether the number of the sixth column is a number other than “0” is determined. Here, the number of the sixth column is a number other than “0”, so the column number “6” is set as the seventh character, and the number “7” of the sixth column is set as the eighth character. (9) Whether the number of the seventh column is a number other than “0” is determined. Here, the number of the seventh column is “0”, so nothing is performed.

Data can be compressed by using the rules such as described above. Data can be effectively compressed with such a method when there are many components in the matrix, which are “0”.

Returning to the explanation of FIG. 14, the resource allocation unit 207 uses the data that was generated at the step S53 to identify the transfer path between the calculation node 2 and the cache server 3, which has the shortest transfer time, or which has the maximum bandwidth (step S55).

At the step S55, the transfer path having the shortest transfer time is identified by using, for example, the Dijkstra's method, A* (A star) method, or the Bellman-Ford method. Moreover, a “group of paths that give the maximum bandwidth” in a case in which plural paths can be used between two points is identified, for example, by using the augmenting path method or the pre-flow push method. At the step S55, the former or the latter is chosen according to the property of the communication. For example, in case of simple data transfer, data is simply divided, so it may be possible to use the latter method that uses plural paths. On the other hand, in the case where data that is sequentially generated by one thread of the program in the calculation node 2 is sequentially written to the disk data storage unit 110, it may be difficult to employ the latter method.

For example, when there is sufficient capacity in the cache 32 of the cache server 3 in the calculation processing system 10, the bandwidth of the communication path between the calculation node 2 and the cache server 3 becomes the cause of limiting the disk access speed. In such a case, candidates for the group of the paths that have the maximum bandwidth are obtained by the latter method, for example, and that group is narrowed down to paths that have the shortest transfer time by the former method.

Returning to the explanation of FIG. 14, the resource allocation unit 207 uses the data that was generated at the step S53 to identify a transfer path for communication between the cache server 3 and the file server 11, which has the shortest transfer time, or which has the maximum bandwidth (step S57). The detailed calculation method of the processing at the step S57 is the same as that at the step S55.

The resource allocation unit 207 identifies the transfer path between the calculation node 2 and the file server 11 by combining the transfer path identified at the step S55 and the transfer path identified at the step S57 (step S59).

The resource allocation unit 207 calculates the transfer time for the determined transfer path (step S61). The processing then returns to the calling-source processing. The transfer time is calculated, for example, using the bandwidth of the transfer path and the amount of data to be transferred. The method for calculating the transfer time is well known, so a detailed explanation is omitted here.

By performing the processing such as described above, a suitable transfer path is determined, so it becomes possible to determine the cache servers 3 (in other words, cache servers 3 on the transfer path) to be used.

Returning to the explanation of FIG. 12, the resource allocation unit 207 calculates the difference between the transfer time that was calculated at the step S61 and the transfer time when transferring data using the original transfer path (step S39). It is also possible to calculate the transfer time when transferring data using the original transfer path, by using the method explained for the step S61.

Then, the resource allocation unit 207 determines whether the difference in the transfer time, which was calculated at the step S39, is longer than the time required for changing the transfer path (step S41). When there is a calculation node 2 that operates as a cache server 3 on the transfer path, the time for converting that calculation node 2 to the cache server 3, and the time for terminating the role of the cache server 3 is added to the time required for changing the transfer path.

When the difference is shorter (step S41: NO route), it is better that the transfer path is not changed, so the processing returns to the step S33. On the other hand, when the difference is longer (step S41: YES route), the resource allocation unit 207 carries out a setting processing to change the transfer path (step S43). More specifically, the resource allocation unit 207 notifies the setting unit 203 of the transfer path after the change. The setting unit 203 sets the IO processing unit 201 so as to use the cache server 3 on the transfer path after the change. Moreover, when the calculation node 2 is converted to the cache server 3, a request to activate the cache processing unit 31 (i.e. cache server process) is outputted to that calculation node 2. The processing then returns to the step S33.

By performing the processing described above, it becomes possible to suitably allocate resources for caching based on the viewpoint of optimizing the transfer path.

Returning to the explanation in FIG. 11, when the predicted input value is equal to or less than a predetermined threshold value (step S15: NO route), the resource allocation unit 207 determines whether or not he predicted output value is greater than a predetermined threshold value (step S19). When the predicted output value is greater than a predetermined threshold value (step S19: YES route), the resource allocation unit 207 carries out the resource allocation processing (step S21). The resource allocation processing is as described in the explanation for the step S17.

On the other hand, when the predicted output value is equal to or less than the predetermined threshold value (step S19: NO route), the IO processing unit 201 carries out the IO processing (in other words, disk access) (step S23). This processing is not a processing that is executed by the resource allocation unit 207, so the block for the step S23 in FIG. 11 is illustrated using a dotted line.

Then, the resource allocation unit 207 determines whether or not the allocation of the resources should be changed (step S25). At the step S25, the resource allocation unit 207 determines whether or not there was a notification from the property manager 205 that is monitoring the state of the job execution unit 204, that the allocation of the resources should be changed. When the allocation of the resources should not be changed (step S25: NO route), the processing returns to the processing of the step S23. However, when the allocation of the resources should be changed (step S25: YES route), the resource allocation unit 207 determines whether or not the execution of the job is continuing (step S27).

When the execution of the job is continuing (step S27: YES route), the allocation of the resources should be changed, so the processing returns to the step S13. On the other hand, when the execution of the job is not continuing (step S27: NO route), the processing ends.

By performing the processing such as described above, the resources are suitably allocated according to the disk access properties in each execution stage of the job, so it becomes possible to increase the speed of the disk access.

Next, the processing by the bandwidth calculation unit 208 will be explained. The bandwidth calculation unit 208 carries out a processing such as described below at every predetermined time.

First, the bandwidth calculation unit 208 calculates the usable bandwidths for the respective communication paths of the calculation node 2, and stores those values in the bandwidth data storage unit 209 (FIG. 21: step S71). There are cases where there are plural jobs using the communication path. When the bandwidth that is used for each job is known in advance, the usable bandwidth can be calculated by subtracting the total of the bandwidths used by the respective jobs from the bandwidth when no communication is performed. When the bandwidth that is used by each of the jobs is not known, predicted values for the usable bandwidths are calculated according to the history of used bandwidths using a prediction equation such as explained at the step S3.

The bandwidth calculation unit 208 stores the bandwidth data in the bandwidth data storage unit 209 even when bandwidth data has been received from other calculation nodes 2, cache servers 3 and file servers 11.

Then, the bandwidth calculation unit 208 transmits a notification that includes the calculated bandwidths to the other nodes (more specifically, calculation nodes 2, cache servers 3 and file servers 11) (step S73). The processing then ends.

By executing the processing such as described above, it becomes possible to know the bandwidth for each communication path that can be used by each of the nodes in the information processing system 1.

### Embodiment 2

Next, a second embodiment will be explained. In this second embodiment, it is determined whether the information processing system. 1 is in a CPU bound state or IO bound state, and the resource allocation is performed based on that determination result. Here, the CPU bound state is a state in which the usable CPU time is a main factor in determining the length of the actual time of the job execution (in other words, the CPU is in a bottleneck state). On the other hand, the IO bound state is a state in which the IO process is a main factor in determining the length of the actual time of the job execution (in other words, IO is in a bottleneck state).

The following presumptions are made for the system in this second embodiment. (1) The calculation nodes 2 and cache nodes 3 exist in the same one partition. (2) It is possible to select whether at least one of a node, CPU or CPU core and memory region is allocated to the calculation node 2 or the cache server 3. (3) It is possible to reference a property data that is obtained in advance at the start of and during the job execution.

A partition is a portion that is logically separated from other portions in the system.

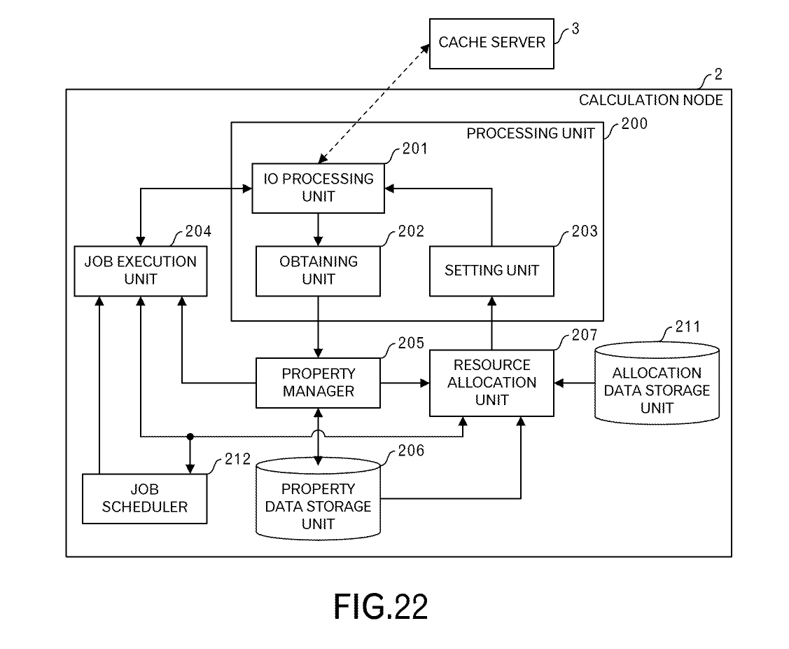

FIG. 22 illustrates a function block diagram of the calculation node 2 in this second embodiment. In the example in FIG. 22, the calculation node 2 includes a processing unit 200 that includes an IO processing unit 201, an obtaining unit 202 and a setting unit 203, a job execution unit 204, a property manager 205, a property data storage unit 206, a resource allocation unit 207, an allocation data storage unit 211 and a job scheduler 212.

The IO processing unit 201 carries out a processing of outputting data received from the cache server 3 to the job execution unit 204, and a processing of transmitting data received from the job execution unit 204 to the cache server 3. The obtaining unit 202 monitors a processing by the IO processing unit 201 and a processing by the CPU, and outputs property data (in this embodiment, this includes the CPU time) to the property manager 205. The job execution unit 204 uses data received from the IO processing unit 201 to execute a job, and outputs the execution results to the IO processing unit 201. The property manager 205 generates property data for each execution stage of the job, and stores that data in the property data storage unit 206. Moreover, the property manager 205 monitors a processing by the job execution unit 204 and requests the resource allocation unit 207 to allocate resources according to the processing state. In response to the request from the property manager 205, the resource allocation unit 207 performs a processing using data stored in the property data storage unit 206 and data stored in the allocation data storage unit 211, and outputs the processing results to the setting unit 203. The setting unit 203 carries out a setting with respect to the cache, for the IO processing unit 201, according to the processing results received from the resource allocation unit 207. The job scheduler 212 carries out the allocation of the resources (for example, CPU or CPU core) for the job execution unit 204, and controls the start and end of the job execution by the job execution unit 204.

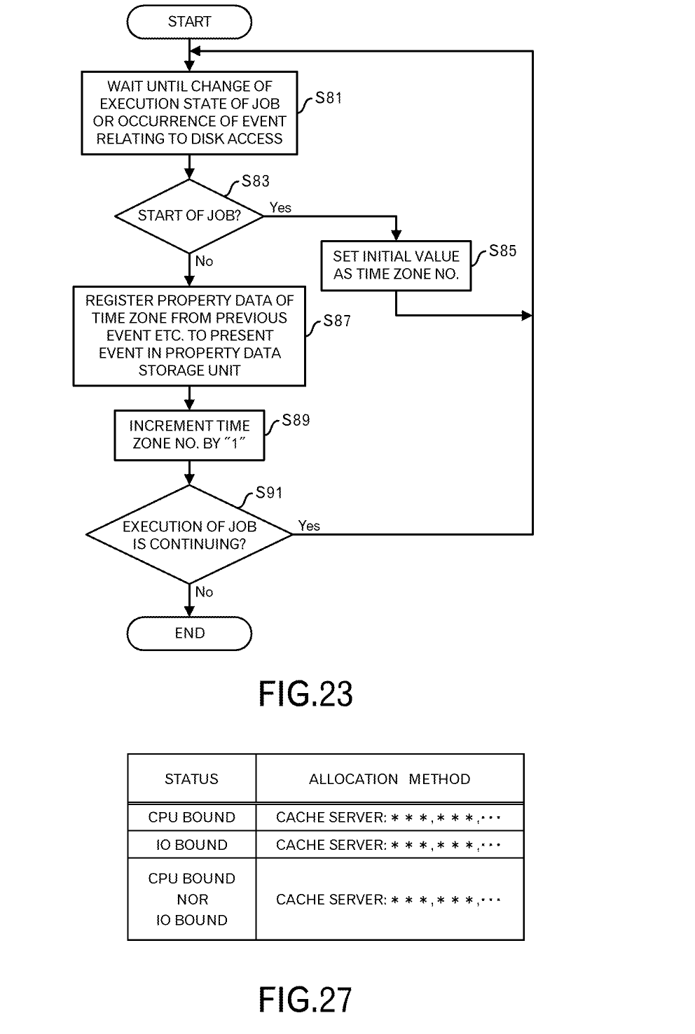

Next, a processing that is carried out by the property manager 205 will be explained. First, the property manager 205 waits until a change occurs in the job execution state or until an event related to the disk access occurs (FIG. 23: step S81). The change in the job execution state is, for example, a change such as the start or end of the job. The occurrence of an event related to the disk access is, for example, the occurrence of an event such as execution of a specific function in a job execution program.

When a change in the job execution state or an event related to the disk access occurs, the property manager 205 determines whether that change or event represents the start of a job (step S83). When the result represents the start of a job (step S83: YES route), the property manager 205 sets an initial value as the time zone number (step S85). The processing then returns to the step S81.

On the other hand, when the result does not represent the start of a job (step S83: NO route), the property manager 205 stores property data for the time zone from the previous event up to the current event, as correlated with the time zone number, in the property data storage unit 206 (step S87).

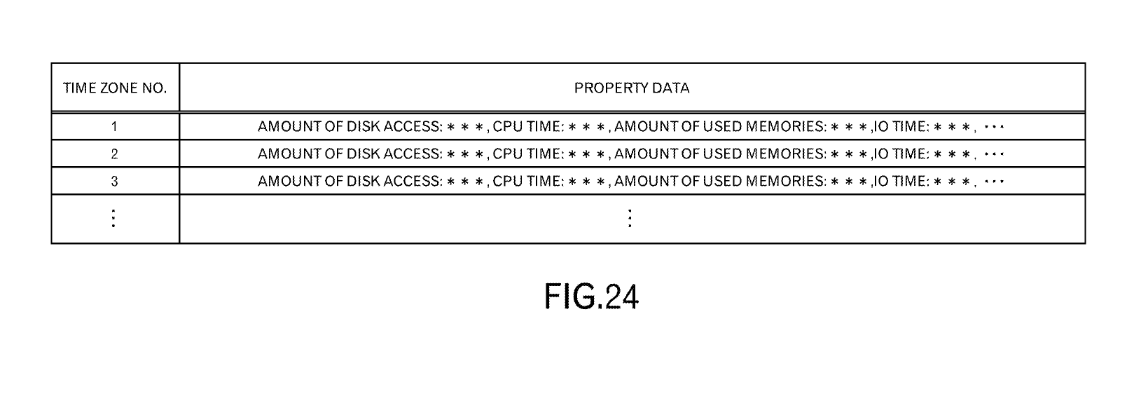

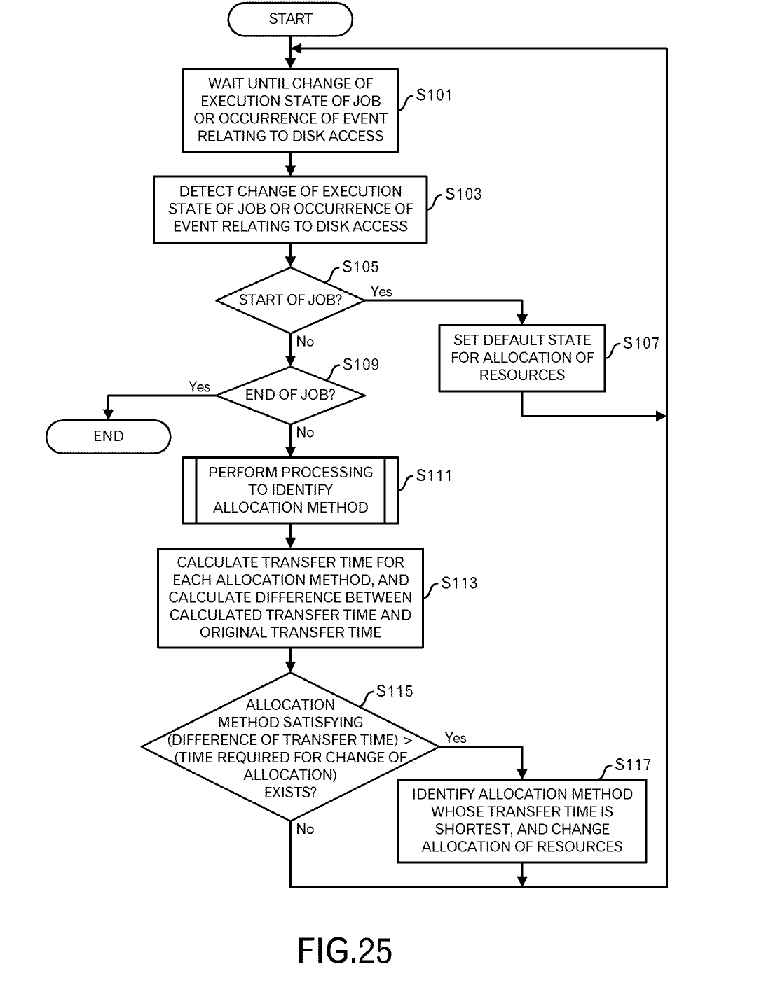

FIG. 24 illustrates an example of data that is stored in the property data storage unit 206. In the example in FIG. 24, the time zone number and property data are stored. The property manager 205 aggregates the property data that was received from the obtaining unit 202 for each time zone, and stores the aggregated data in the property data storage unit 206. The IO time is calculated, for example, by “(the length of a time zone)—(CPU time)”. Information about the length of each time zone may be stored in the property data storage unit 206, and then at the step S111 (FIG. 25), the resource allocation unit 207 may be notified.

The property manager 205 then increases the time zone number by 1 (step S89). The property manager 205 determines whether or not execution of the job is continuing (step S91). When the job execution is continuing (step S91: YES route), the processing returns to the step S81 to continue the processing.

On the other hand, when the execution of the job is not continuing (step S91: NO route), the processing ends.

By performing the processing such as described above, the property data is aggregated beforehand for each stage of the program execution (each time zone in the example described above) and it becomes possible to use aggregated data in a later processing.

Next, a processing that is performed for jointly allocating the resources by the property manager 205 and the resource allocation unit 207 will be explained.

First, the property manager 205 waits until a change in the job execution state is detected or until an event related to the disk access occurs (FIG. 25: step S101). Then, the property manager 205 detects that the change in the job execution state or an event related to the disk access has occurred (step S103).

The property manager 205 determines whether or not the detection represents the start of a job (step S105). When the detection represents the start of a job (step S105: YES route), the property manager 205 sets a default state for the allocation of the resources (step S107). At the step S107, the resource allocation unit 207 requests the setting unit 203 to set the default state for the allocation of resources. The setting unit 203 sets the default state for the allocation of the resources in response to this request. For example, the setting unit 203 carries out setting for the IO processing unit 201 so as to use only predetermined cache servers 3.

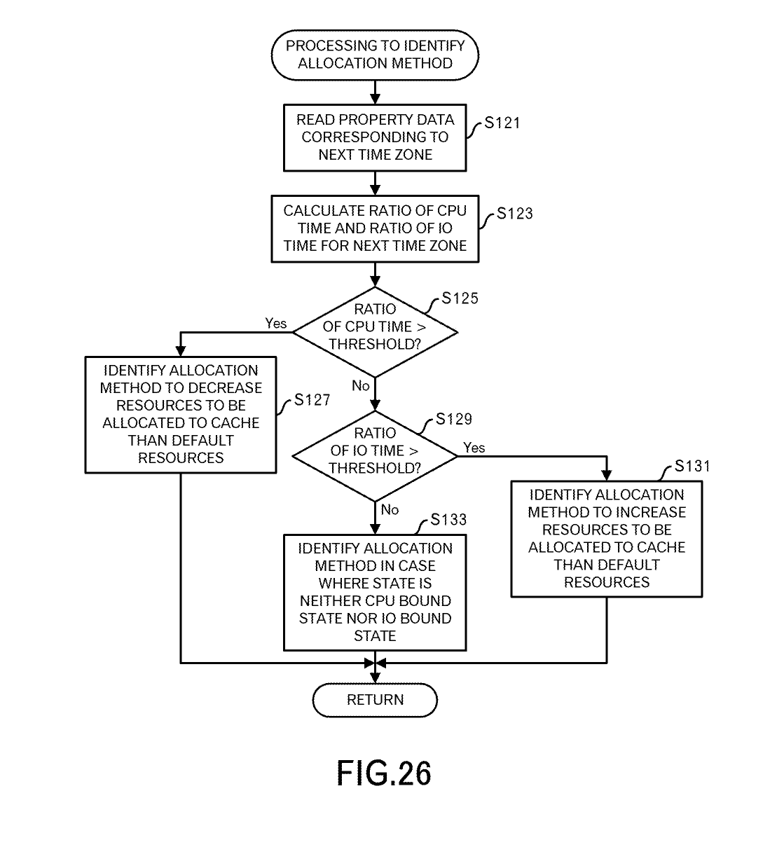

On the other hand, when the detection does not represent the start of a job (step S105: NO route), the property manager 205 determines whether or not the detection represents the end of a job (step S109). When the detection represents the end of a job (step S109: YES route), the processing ends. When the detection does not represent the end of a job (step S109: NO route), the property manager 205 notifies the resource allocation unit 207 of the time zone number of the next time zone, and requests the resource allocation unit 207 to carry out a processing for identifying an allocation method. In response to this request, the resource allocation unit 207 executes the processing for identifying the allocation method (step S111). The processing for identifying the allocation method will be explained using FIG. 26.

First, the resource allocation unit 207 reads property data corresponding to the next time zone from the property data storage unit 206 (step S121).

The resource allocation unit 207 calculates a ratio of the CPU time and a ratio of the IO time for the next time zone (step S123). At the step S123, the ratio of the CPU time is calculated by (CPU time)/(the length of the next time zone), and the ratio of the IO time is calculated by (IO time)/(the length of the next time zone).

The resource allocation unit 207 determines whether or not the ratio of the CPU time is greater than a predetermined threshold value (step S125). When the ratio of the CPU time is greater than the predetermined threshold value (step S125: YES route), the resource allocation unit 207 identifies, from the allocation data storage unit 211, an allocation method, which will decrease the resources to be allocated to the cache than the default resources (step S127). This is because more resources should be allocated to the job execution than the disk access.

FIG. 27 illustrates an example of data that is stored in the allocation data storage unit 211. In the example in FIG. 27, identification information of the state, and the allocation method are stored. In the column of the allocation method, identification information of nodes that operate as cache servers 3 is stored, for example. The allocation method that corresponds to the CPU bound state is an allocation method to reduce the resources to be assigned to the cache among the resources in the partition than the default resources. The allocation method that corresponds to the IO bound state is an allocation method to increase the resources to be assigned to the cache among the resources in the partition than the default resources. In the column of the allocation method corresponding to a case where a state is neither the CPU bound nor IO bound, an allocation method whose cost required for the allocation change is less than the effect of the improvement is stored, for example. However, when there is hardly any cost necessary for the allocation change, both an allocation method for increasing the resources to be allocated to the cache, and an allocation method for decreasing the resources to be allocated to the cache may be stored. Moreover, in the case where the cost required for the allocation change is greater than the effect of the improvement, nothing may be stored.

The threshold value at the step S125 and the threshold value at the step S129 are set such that a “CPU bound and IO bound” state does not occur.

Returning to the explanation of FIG. 26, when the ratio of the CPU time is equal to or less than the predetermined threshold vale (step S125: NO route), the resource allocation unit 207 determines whether or not the ratio of the IO time is greater than a predetermined threshold value (step S129).

When the ratio of the IO time is greater than the predetermined threshold value (step S129: YES route), the resource allocation unit 207 identifies, from the allocation data storage unit 211, an allocation method that increases the resources to be allocated to the cache than the default (step S131).

On the other hand, when the IO time is equal to or less than the predetermined threshold value (step S129: NO route), the resource allocation unit 207 identifies, from the allocation data storage unit 211, an allocation method in a case in which a state is neither the CPU bound state nor IO bound state (step S133). The processing then returns to the calling-source processing.

By performing the processing such as described above, it becomes possible to allocate resources to either the disk access or job execution, which is in a bottleneck state.

Returning to the explanation of FIG. 25, the resource allocation unit 207 calculates the transfer time for each of the allocation methods that were identified at the step S111, and calculates the difference between that transfer time and the original transfer time (step S113). At the step S113, for example, the resource allocation unit 207 identifies a transfer path in a case where the cache would be allocated by each allocation method, and calculates the transfer time for the identified transfer path by using the method that was described for the step S61.

Then, the resource allocation unit 207 determines whether or not there is an allocation method that satisfies a condition (the difference in transfer time, which is calculated at the step S113)>(time required for the allocation change) (step S115). When there is no allocation method that satisfies that condition (step S115: NO route), the processing returns to the step S101. However, when there is an allocation method that satisfies that condition (step S115: YES route), the resource allocation unit 207 identifies an allocation method that has the shortest transfer time from among the allocation methods that satisfy this condition, and changes the allocation of the resources (step S117). More specifically, the resource allocation unit 207 notifies the setting unit 203 of the allocation method. The setting unit 203 carries out setting for the IO processing unit 201 so as to perform the processing according to the changed allocation method. Moreover, when the calculation node 2 is converted to the cache server 3, that calculation node 2 is requested to activate the cache processing unit 31 (in other words, a process of the cache server program). The processing then returns to the step S101.

By carrying out the processing as described above, the resources in the information processing system 1 are suitably allocated to portions that may be a bottleneck in the processing, so it becomes possible to improve the throughput of the information processing system 1.

### Embodiment 3

Next, a third embodiment will be explained. In this third embodiment, property data is extracted from the execution program of a job.

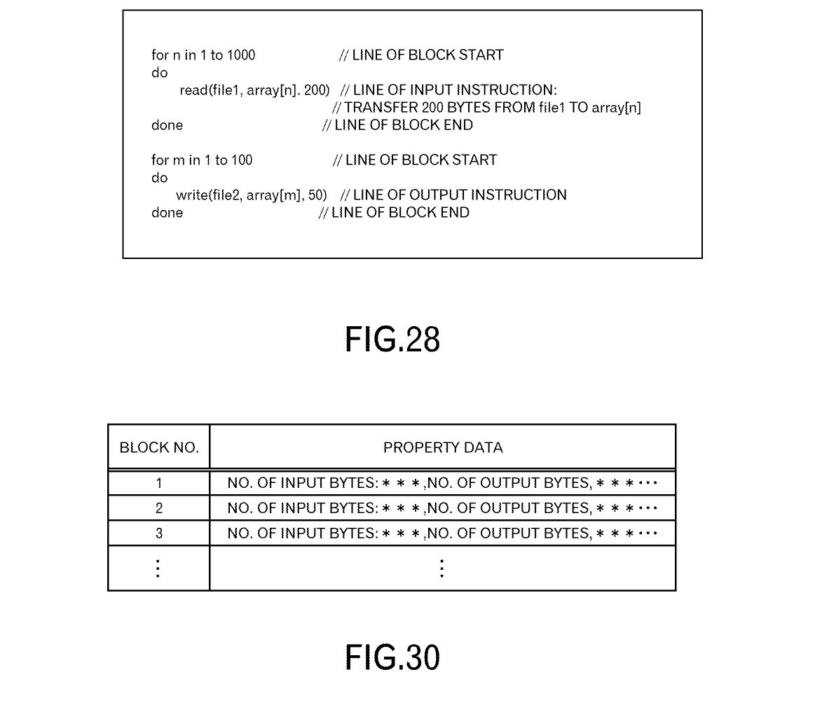

FIG. 28 illustrates an example of an execution program of a job. In the example in FIG. 28, the execution program for the job is divided into two blocks. In the first block, a processing related to the input is described, and in the second block, a processing related to the output is described. In this third embodiment, property data is extracted with this kind of block construction of the execution program for the job as a key.

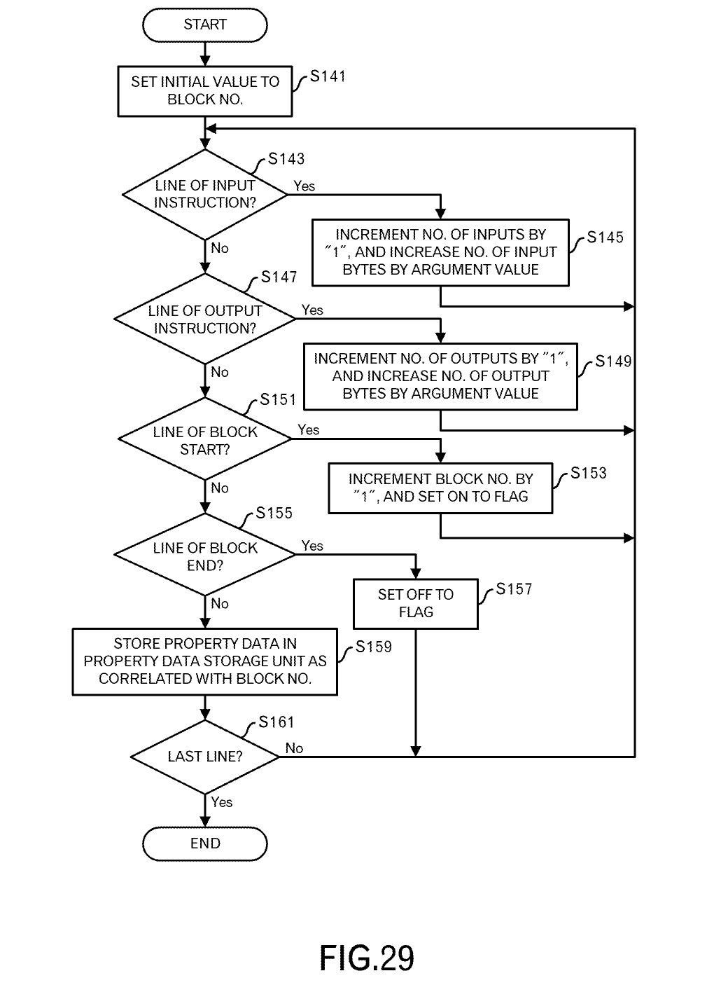

Next, the processing that is performed by the property manager 205 will be explained. First, the property manager 205 initializes the block number (FIG. 29: step S141).

The property manager 205 determines whether or not the read line is an input instruction line (step S143). When the line is an input instruction (step S143: YES route), the property manager 205 increments the number of inputs by “1”, and increases the number of input bytes by the argument amount (step S145). Then, the processing returns to the processing of the step S143. On the other hand, when the line is not an input instruction (step S143: NO route), the property manager 205 determines whether or not the read line is an output instruction line (step S147).

When the line is an output instruction line (step S147: YES route), the property manager 205 increments the number of outputs by “1”, and increases the number of output bytes by the argument amount (step S149). The processing then returns to the step S143. On the other hand, when the line is not an output instruction (step S147: NO route), the property manager 205 determines whether or not the read line is a line of the start of a block (step S151).

When the line is a line of the start of a block (step S151: YES route), the property manager 205 increments the block number by “1”, and sets ON to a flag (step S153). The flag to be set at the step S153 is a flag that represents that the block is being processed. On the other hand, when the line is not a line of the start of a block (step S151: NO route), the property manager 205 determines whether or not the line is a line of the end of the block (step S155).

When the line is a line of the end of the block (step S155: YES route), the property manager 205 sets OFF to the flag, and the processing returns to the step S143 (step S157). However, when the line is not a line of the end of the block (step S155: NO route), the property manager 205 stores the property data (for example, the number of input bytes, the number of output bytes, and the like) in the property data storage unit 206 in association with the block number (step S159).

FIG. 30 illustrates an example of data that is stored in the property data storage unit 206. In the example in FIG. 30, the block number and property data are stored.

Then, the property manager 205 determines whether or not the line is the last line of the execution program of a job (step S161). When the line is not the last line (step S161: NO route), the processing returns to the step S143 in order to process the next line. On the other hand, when the line is the last line (step S161: YES route), the processing ends.

In this way, in this third embodiment, the execution stages of a job are divided with the blocks in the execution program of a job as a key. In this second embodiment, the execution stages of the job were divided with time zones, however, in this third embodiment as well, it is possible to allocate resources according to the disk access properties as in the second embodiment.

### Embodiment 4

Next, a fourth embodiment will be explained. In this fourth embodiment, by allocating resources according to stage-in and stage-out, it becomes possible to allocate the resources without using property data.

In execution of a batch job, the following control is performed in order to suppress an increase in network traffic, in which occurs due to accessing files on a file server.

At the start of job execution, a file on a remote file server is copied to a local file server. This process is called file “stage-in”. During execution of a job, the file on the local file server is used. At the end of the job execution, the file on the local file server is written back to the remote file server. This processing is called “stage-out” of the file.

The stage-in and stage-out of the file are controlled, for example, by one of the following methods.

Control is conducted by describing the stage-in and stage-out in a script file that is interpretedby the job scheduler. Stage-in is executed before execution of the job execution program, and stage-out is executed after the execution of the job execution program, with both the stage-in and stage-out being independent of the job execution program, as part of the processing of the job scheduler. Control is performed with operation of the execution program of the job as a trigger. For example, the stage-in is carried out as extension of a processing that the execution program of the job initially opens a file, and the stage-out is carried out when finally closing a file or when ending the final process. Detection of the stage-in and stage-out is executed by monitoring the execution program of the job during its execution, and catching an operation “the first opening”, “last closing” or “ending process” as “events”.

At the stage-in and stage-out of a file, the calculation node 2 can naturally predict the IO bound state without using the property data. Therefore, in this embodiment, an example of allocating resources by using a script file will be explained.

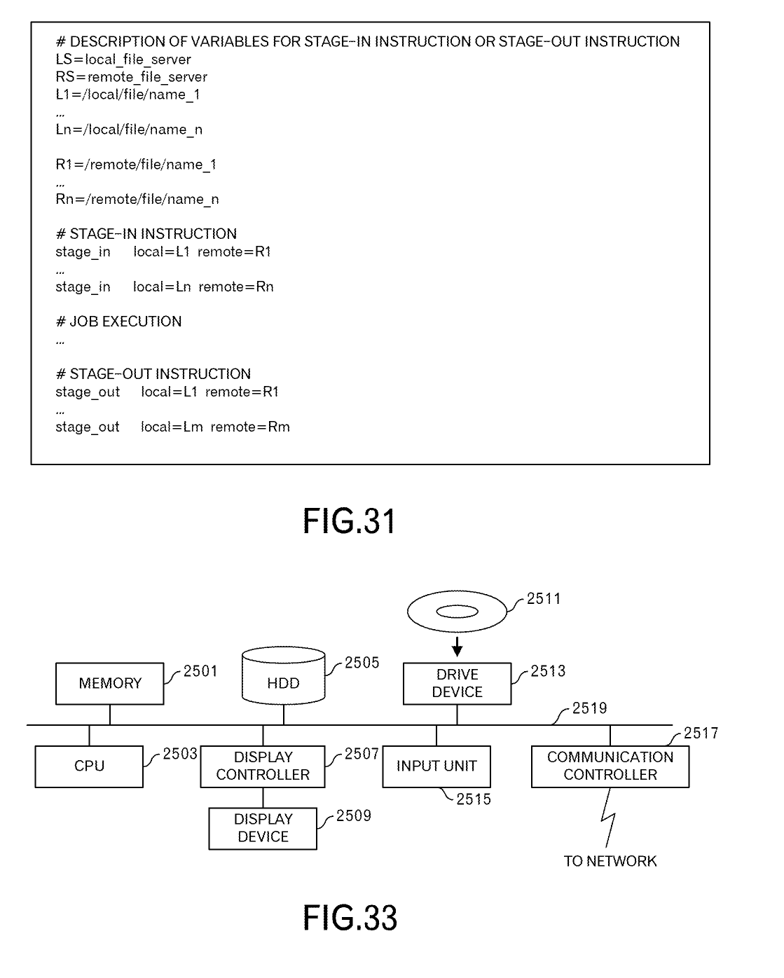

FIG. 31 illustrates an example of a script file that the job scheduler 212 interprets. The script file in FIG. 31 includes variable description for instructing a stage-in and stage-out, description of a stage-in instruction and description of a stage-out instruction.

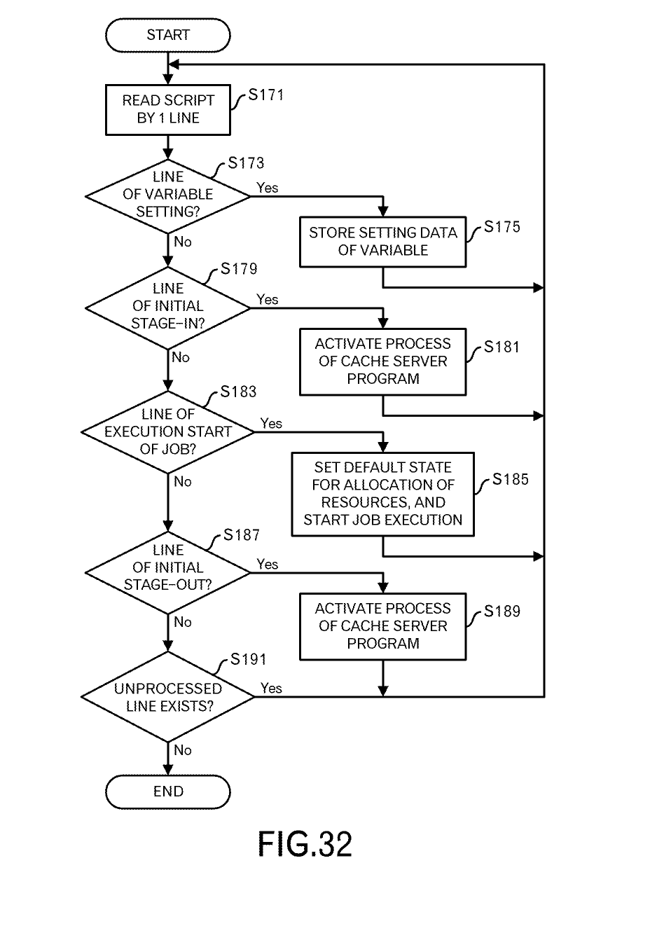

Next, the processing by the job scheduler 212 will be explained using FIG. 32. First, the job scheduler 212 reads one line of script (FIG. 32: step S171).

The job scheduler 212 determines whether or not that line is a line for a variable setting (step S173). When the line is a line for a variable setting (step S173: YES route), the job scheduler 212 stores the setting data for the variable in a storage device such as a main memory (step S175). Then, the processing returns to the step S171. The setting data for the variable is used later when instructing the stage-in or stage-out. On the other hand, when the line is not a line for the variable setting (step S173: NO route), the job scheduler 212 determines whether or not the line is the first stage-in line (step S179).

When the line is the first stage-in line (step S179: YES route), the job scheduler 212 activates the process of the cache server program in the calculation node 2 (step S181). The processing then returns to the step S171. As a result, the resources such as the memory and CPU or CPU core in the calculation node 2, or the communication bandwidth of the network are used for the disk access by the cache server program. On the other hand, when the line is not the first stage-in line (step S179: NO route), the job scheduler 212 determines whether or not the line is a line for the start of the job execution (step S183).

When the line is a line for the start of the job execution (step S183: YES route), the job scheduler 212 sets the default state for the allocation of the resources, and causes the job execution unit 204 to start the execution of the job (step S185). The processing then returns to the processing of the step S171. As a result, the resources such as the memory and CPU or CPU core in the calculation node 2 are used for the execution of the job by the job execution unit 204. On the other hand, when the line is not a line for the start of the job execution (step S183: NO route), the job scheduler 212 determines whether or not the line is the first stage-out line (step S187).

When the line is the first stage-out line (step S187: YES route), the job scheduler 212 activates the process of the cache server program (step S189). The processing then returns to the step S171. However, when the line is not the first stage-out line (step S187: NO route), the job scheduler 212 determines whether or not there is an unprocessed line (step S191). When there is an unprocessed line (step S191: YES route), the processing returns to the step S171 in order to process the next line.

On the other hand, when there are no unprocessed lines (step S191: NO route), the processing ends.

By performing the processing as described above, it becomes possible to reduce the time necessary for stage-in and stage-out.

Although the embodiments of this invention were explained, this invention is not limited to the embodiments. For example, the functional block configurations of the aforementioned calculation nodes 2 and cache servers 3 may not always correspond to program module configurations.

Moreover, the aforementioned table configurations of the respective tables are mere examples, and may be modified. Furthermore, as for the processing flow, as long as the processing results do not change, the turns of the steps may be exchanged or the steps may be executed in parallel.

Moreover, when the shortage of the capacity of the cache 32 occurs or is predicted in the cache server 3, the writing back to the disk data storage unit 110 may be carried out according to the priority set by a method such as First In First Out (FIFO) or Least Recently Used (LRU). When the shortage of the capacity of the cache 32 cannot be avoided even if such a method is employed, time until the vacancy occurs in the memory in the cache server 3 by writing back to the disk data storage unit 110 may be added to the transfer time of the transfer path passing through that cache server 3.

Moreover, in the aforementioned example, the cache 32 is provided in the memory, however, the cache 32 may be provided on a disk device. For example, when the cache server 3 having that disk device is near the calculation node 2 (e.g. the cache server 3 can reach the calculation node 2 with a few hops), the network delay and the load concentration to the file server 11 may be suppressed even when the disk device is provided, for example.

Moreover, in the second embodiment, when the execution of the job is started by the job scheduler 212, the allocation of the resources is carried out according to the default setting, however, following methods may be employed. In other words, in case where it is predicted that the state does not become the IO bound state when starting the execution of the job, the number of nodes to be allocated to the cache in the partition may be decreased compared with the normal case. Moreover, when it is predicted that the state becomes the IO bound state when starting the execution of the job, the number of nodes to be allocated to the cache in the partition may be increased compared with the normal case.

In addition, the aforementioned calculation nodes 2, cache servers 3 and file servers 11 are computer devices as illustrated in FIG. 33. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as illustrates in FIG. 33. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

The embodiments described above are summarized as follows:

An information processing method relating to the embodiments includes (A) obtaining data representing a property of accesses to a disk device for a job to be executed by using data stored in a disk device (e.g. hard disk drive, Solid State Drive or the like) on a first node in a network including plural nodes; and (B) determining a resource to be allocated to a cache among resources in the network based on at least the data representing the property of the accesses.

Thus, it becomes possible to appropriately arrange the cache in the network including the plural nodes.

Moreover, the aforementioned data representing the property of the accesses may include information on an amount of data to be transferred by the accesses to the disk device. Then, the determining may include (b1) when the amount of data is equal to or greater than a first threshold, using data on a bandwidth, which was received from another node in the network to determine a transfer path up to the first node so that a transfer time of data becomes shortest or a bandwidth for transferring data becomes maximum, and allocating a resource of a node on the transfer path to the cache. Thus, it becomes possible to determine the allocation of the resources so as to maximize the speed of the accesses to the disk device.

Moreover, the determining may further include: (b2) generating a weighted directed graph in which each node in the network is a vertex, each communication path in the network is an edge, a bandwidth of each communication path is a weight, and a data transfer direction is a direction of the edge; (b3) determining a path of a section up to a node having a resource to be allocated to the cache within the transfer path up to the first node, by applying a first algorithm to the weighted directed graph; and (b4) determining a path of a section from the node having the resource to be allocated to the cache to the first node within the transfer path up to the first node, by applying a second algorithm different from the first algorithm to the weighted directed graph. The property of the data transfer may be different among sections even in the same transfer path. Then, by carrying out the aforementioned processing, it becomes possible to apply an appropriate algorithm to each section.

Moreover, the generating may include: (b21) generating the weighted directed graph by generating a vertex by virtually aggregating a portion of the plural nodes in the network to one node, by generating an edge by virtually aggregating plural communication paths in the network to one communication path and by setting a total of bandwidths of the plural communication paths in the network as a virtual bandwidth of the one communication path corresponding to the plurality of communication paths. By doing so, it becomes possible to reduce the calculation load when determining the transfer path.

In addition, the obtaining may include (a1) further obtaining a CPU time required for execution of the job and a second time required for a processing to access the data stored in the storage device, and then, the determining may include (b5) determining an allocation method of the resources of the plural nodes, based on the CPU time and the second time. Thus, because resources can be allocated to either of the job execution or accesses to the disk device, which is a bottleneck, it becomes possible to enhance the throughput of the system.

In addition, the obtaining may include (a2) obtaining data representing the property of the accesses by monitoring accesses to the data stored in the storage device during execution of the job. Thus, it becomes possible to appropriately obtain the data representing the property of the accesses.

Moreover, the obtaining may include (a3) obtaining the data representing the property of the accesses from a data storage unit storing the data representing the property of the accesses during execution of the job. For example, when the data representing the property of the accesses has been prepared in advance, such data can be utilized.

Furthermore, the obtaining may include (a4) generating the data representing the property of the accesses by analyzing an execution program of the job before the execution of the job and storing the generated data to a data storage unit. Thus, by utilizing the execution program of the job, it is possible to prepare data representing the property of the accesses in advance.

Moreover, the obtaining may include (a5) obtaining the data representing the property of the accesses for each execution stage of the job. Then, the determining may include (b6) determining a resource to be allocated to the cache for each execution stage of the job. By doing so, it becomes possible to dynamically handle cases according to the access property for each execution stage of the job.

In addition, this information processing method may further include (C) detecting an execution start of the job or an execution end of the job by analyzing a program for controlling execution of the job or monitoring the execution of the job; and (D) upon detecting the execution start of the job or the execution end of the job, increasing a resource to be allocated to the cache in a resource in either of the plurality of nodes. Thus, it becomes possible to increase the resource to be allocated to the cache so as to adapt to the stage-in or stage-out for example.

In addition, the first algorithm or the second algorithm may be at least one of a dijkstra method, an A* method, a Bellman-Ford algorithm, an augmenting path method and a pre-flow push method. According to this, it becomes possible to appropriately determine the transfer path so that the data transfer time becomes shortest or the bandwidth for transferring data becomes maximum.

Moreover, the resource in the parallel computer system may include at least either of a central processing unit or a central processing unit core and a memory or a memory region. Thus, it becomes possible to allocate appropriate resources to the cache.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory storage medium storing a program for causing a node of a plurality of nodes that are connected in a parallel computer system through a network to execute a procedure, the procedure comprising:
obtaining property data representing a property of accesses to data stored in a storage device in a first node of the plurality of nodes for a job to be executed by using data stored in the storage device; and
determining a resource to be allocated to a cache among resources included in the parallel computer system and the network based on the obtained property data.

2. The computer-readable, non-transitory storage medium as set forth in claim 1, wherein the property data is information on an amount of data to be transferred by the accesses to the data stored in the storage device, and
the determining comprises:
upon detecting that the amount of data is equal to or greater than a first threshold, using bandwidth data received from another node of the plurality of nodes to determine a transfer path up to the first node so that a data transfer time becomes shortest or a bandwidth for transferring data becomes maximum; and
allocating a resource of a node on the determined transfer path to the cache.

3. The computer-readable, non-transitory storage medium as set forth in claim 2, wherein the determining further comprises:
generating a weighted directed graph in which each of the plurality of nodes in the network is a vertex, each communication path in the network is an edge, a bandwidth of each communication path is a weight, and a data transfer direction is a direction of the edge;
determining a path of a section up to a node having a resource to be allocated to the cache within the transfer path up to the first node, by applying a first algorithm to the weighted directed graph; and
determining a path of a section from the node having the resource to be allocated to the cache to the first node within the transfer pathup to the first node, by applying a second algorithm different from the first algorithm to the weighted directed graph.

4. The computer-readable, non-transitory storage medium as set forth in claim 3, wherein the generating comprises:
generating the weighted directed graph by generating a vertex by virtually aggregating a portion of the plurality of nodes in the network to one node, by generating an edge by virtually aggregating a plurality of communication paths in the network to one communication path and by setting a total of bandwidths of the plurality of communication paths in the network as a virtual bandwidth of the one communication path corresponding to the plurality of communication paths.

5. The computer-readable, non-transitory storage medium as set forth in claim 1, wherein the property data includes a first time required for execution of the job and a second time required for a processing to access the data stored in the storage device, and
the determining comprises determining an allocation method of the resources of the plurality of nodes, based on the first time and the second time.

6. The computer-readable, non-transitory storage medium as set forth in claim 1, wherein the obtaining comprises obtaining the property data by monitoring accesses to the data stored in the storage device during execution of the job.

7. The computer-readable, non-transitory storage medium as set forth in claim 1, wherein the obtaining comprises obtaining the property data from a data storage unit storing the property data during execution of the job.

8. The computer-readable, non-transitory storage medium as set forth in claim 7, wherein the obtaining comprises generating the property data by analyzing an execution program of the job before the execution of the job.

9. The computer-readable, non-transitory storage medium as set forth in claim 1, wherein the obtaining comprises obtaining the property data for each execution stage of the job, and
the determining comprises determining a resource to be allocated to the cache for each execution stage of the job.

10. The computer-readable, non-transitory storage medium as set forth in claim 1, wherein the procedure further comprises:
detecting an execution start of the job or an execution end of the job by analyzing a program for controlling execution of the job or monitoring the execution of the job; and
upon detecting the execution start of the job or the execution end of the job, increasing a resource to be allocated to the cache in a resource in either of the plurality of nodes.

11. The computer-readable, non-transitory storage medium as set forth in claim 3, wherein the first algorithm or the second algorithm is at least one of a dijkstra method, an A* method, a Bellman-Ford algorithm, an augmenting path method and a pre-flow push method.

12. The computer-readable, non-transitory storage medium as set forth in claim 1, wherein the resource in the parallel computer system includes at least either of a central processing unit or a central processing unit core and a memory or a memory region.

13. A control method, comprising:
obtaining, by using a node of a plurality of nodes that are connected in a parallel computer system through a network, property data representing a property of accesses to data stored in a storage device in a first node of the plurality of nodes for a job to be executed by using data stored in the storage device; and
determining by using the node, a resource to be allocated to a cache among resources included in the parallel computer system and the network based on the obtained property data.

14. A parallel computer system, comprising:
a plurality of nodes that are connected through a network, and
wherein each node of the plurality of nodes comprises:
a memory; and
a processor using the memory and configured to execute a procedure, the procedure comprising:
obtaining property data representing a property of accesses to data stored in a storage device in a first node of the plurality of nodes for a job to be executed by using data stored in the storage device; and
determining a resource to be allocated to a cache among resources included in the parallel computer system and the network based on the obtained property data.
